(19) United States
(12) Patent Application Publication
(10) Pub. No.: US 2008/0102421 A1
(43) Pub. Date: May 1, 2008

(54) Method For Rating Talent Ability Based On Creative Works

(76) Inventor: James S. Beach Drummond, Winter Park, FL (US)

Correspondence Address: James H. Beusse, Esquire;Beusse Wolter Sanks Mora & Maire, P.A., Suite 2500, 390 North Orange Avenue, Orlando, FL, 32801, US

(21) Appl. No.: 11/928,776

(22) Filed: Oct. 30, 2007

Related U.S. Application Data
(60) Provisional application No. 60/863,831, filed on Nov. 1, 2006.

(51) Int. Cl. G09B 11/00

(52) U.S. Cl. 434/81

(57) ABSTRACT

A talent analysis and evaluation method for an artist uses a group of experts in the artistic category of the arts to review and evaluate a body of work from the artist. The body of work includes a plurality of items in the artistic category. Each of the experts of the group of experts independently evaluates each of the items in the body of work received from the artist and each of the experts provides a numerical rating for each item in the body of work. The ratings from each of the experts is normalized to a predetermined scale and a final composite rating for the body of work of the artist is computed.

### SPECIFIC DATA RELATED TO THE INVENTION

This application claims the benefit of U.S. provisional patent application, No. 60/863,831 filed Nov. 1, 2006.

This invention relates to a method for providing an evaluation of an artist ability based on rating a collection of works from the artist.

### BACKGROUND OF THE INVENTION

An artist's career is generally determined by public acceptance and appreciation of the artist's work, whether the artist is an actor, a writer, a painter, a musician, a sculptor or other creator of artistic work. In most cases, many years of development often precede public recognition of the artist's ability or talent. In some instances, appreciation does not occur prior to the death of the artist. Various methods have been utilized to promote works of an aspiring artist in order to try and jump-start a career. For example, promoters have paid radio stations to play works of a selected artist while other promoters have used vast advertising campaigns to call public attention to an artist. However, there is often a period when the artist is developing and honing his talent before the promoter is willing to risk capital in advancing the artist's career.

Recently, there have been a number of “reality TV” programs to identify and promote new artists. These programs often involve a group of professional entertainers who rate the artists and their ratings are sometimes combined with audience ratings to determine which artist is least appreciated. That artist is then eliminated from the competition. Eventually, one artist is left and becomes the winner. While such a system may be useful in identifying at least one artist that is at a point in their career where such a closed competition allows them to move to another level, the system does not enable the general population of artists to determine where they are in their development. Further, such competitions are limited to artists that are perceived as suitable for entertaining in certain talent categories such as the music and dancing arenas, i.e., the competitions are not suitable for developing artists in other fields such as painting, photography or sculpture.

U.S. Pat. No. 7,162,433 discusses the problems of artists or producers of artistic content in being able to obtain professional opinion of their products. That patent recognizes the difficulty for producers of content to receive expert reviews of their works, whether the content is audio-visual (movies, music, books, scripts, etc.), or otherwise. Further, without expensive research, artists are unable to obtain marketing research and consumer feedback data about their level of development.

While the internet has done a lot to relieve some of the problems association with development of a new artist by providing web sites where artists can present their works and receive public opinion, these sites generally do not provide for professional review. Further, voting or comments on the sites may carry a biased opinion, as it is often given by persons associated with the artist rather than from independent viewer opinion. In addition, as the Internet has become the number one location for artists to display their works, over physical locations such as art galleries and exhibitions, it has also swelled with artistic content, creating information overload and clutter as millions of artists regularly display their work in both personal and network websites.

### SUMMARY OF THE INVENTION

The present invention is directed to a system and method that provides for a standardized rating system for talented individuals, in which an artist or other talented personality type submits a body of work (multiple items) to be judged by a randomly assigned committee of industry specialists, in order to calculate a single numerical talent rating derived from a combination of the collective scores of all participating committee members. The body of work is reviewed and critiqued on the merits of several artistic attributes which are predetermined according to the type (classification) of talent being evaluated. The body of work is rated by each member of the committee then mathematically combined through an algorithm to provide a single talent score per committee member. A secondary mathematical algorithm combines the scores from the individual committee members to calculate a single, combined numerical talent rating consistent with the perceived artistic merits of a submitted body of work.

This score then carries forth with the artist through their lifetime, and may be affected by subsequent ratings from additional “bodies of work” that the artist may submit from time to time, through the same rating process. If, over time, multiple bodies of work are submitted by the artist, then the entirety of the artist's “talent ratings”, per each body of work, are averaged to generate a single numerical representation of the artist's “lifetime talent rating”. This lifetime rating is symbolic of the career merits of the artists as perceived by specialists in specific artistic fields, and can then be compared with other artists in a given population sample, such as on an Internet website or at an art gallery, to create a system and method of weighing one artist's talent and/or creative ability with another.

Unlike talent rating methods and competitions that focus on a limited and closed controlled group, the prevent invention provides a rating service for the entire artist population without regard for artistic merit, geography, social status or other limitations that often prohibit artists from entering such competitions and juried events.

The present invention can be utilized with any type of artistic work including, for example, paintings, photographs, sculpture, music, song writing, poetry and all other items of artistic merit. In the case of a painting, for example, a group of specialists in the field of painting would each be given an opportunity to review the painting and to evaluate the painting based on a pre-selected group of parameters. For example, the parameters may comprise Global Aptitude, Innate Skill, Technical Merit, Use of Media, and Creative Uniqueness. Each of the parameters may be assigned the same or a different weighted value. In a preferred embodiment, the sum of all weighted values multiplied by the specialist's rating of the associated parameter would have a maximum value, such as, for example, 1000. While various rating schemes may be used, an exemplary scheme would use a rating system of 1 through 10, where 10 is the highest rating and 1 is the lowest. If each parameter were given the same weight, a multiplier of 20 for each of the above enumerated five parameters would yield a perfect score of 1,000. However, it is anticipated that the parameters would each have a different rating but that the average weighted multiplier would be 20.

### BRIEF DESCRIPTION OF THE DRAWINGS

FIG. 1 is a functional block diagram of the overall process of talent rating in accordance with a preferred embodiment of the present invention; and

FIG. 2 is a functional block diagram illustrating one form of the algorithm used in the block diagram of FIG. 1.

### DETAILED DESCRIPTION OF THE INVENTION

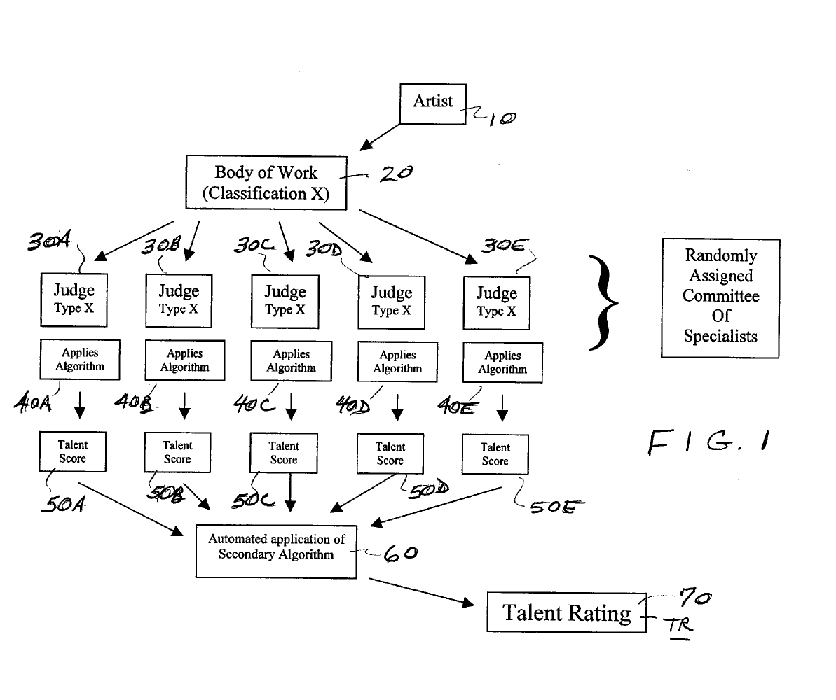

An overall illustrative of the present inventive method is shown in FIG. 1. Block 10 represents an artist that presents a body of work for evaluation. Preferably, the artist would submit several examples of his/her work since the intent is to provide both an evaluation of a particular work and also an evaluation that is helpful to the artist in evaluating his/her current skills/talent. At block 20 the submitted work is initially evaluated for classification purposes, i.e., is this a painting, sculpture, etc. The initial classification allows for proper selection of judges to review the work, i.e., the judges skill set must match the type of work being evaluated. It is intended that the pool of judges be sufficiently large that a random selection of judges can be drawn from the pool for evaluating a body of work. At blocks 30A to 30E, the works are allotted out to appropriate judges having skills in the particular type of work being evaluated. As noted above, the works may be different and the judges may be organized into different panels for each type of work. If the works are all the same genre, it would be possible to use a single panel of judges for all works of one artist. Accordingly, each of the blocks 30A to 30E could represent different judging panels or a single judge in one panel.

Each judge rates the work of the artist for each of the selected parameters, such as those listed above. The individual ratings for each parameter are then multiplied by the weighting factor and all of the weighted ratings summed to provide a net rating for each judge, as is indicated by blocks 40A to 40E. The net result then becomes the talent score, blocks 50A to 50E. All of the talent scores are then processed using a different algorithm, block 60, to create the final talent rating, block 70.

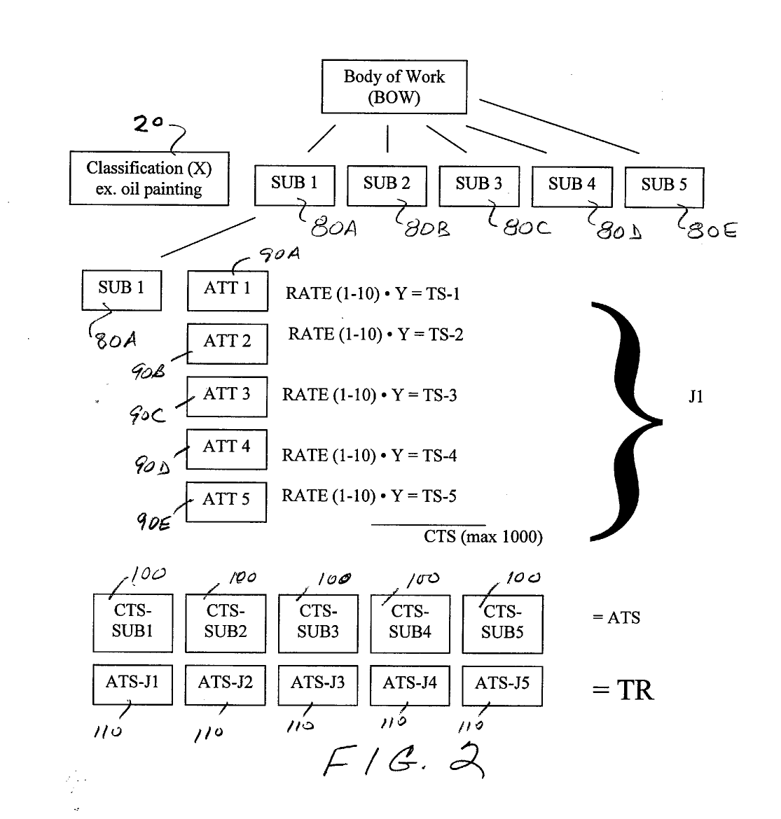

To better under understand how the method is employed, reference is now made to FIG. 2. Assume that an artist submits a body of work (BOW) and that the BOW consists of five oil paintings as determined at classification block 20. A committee comprised of five randomly selected judges (J1-J5) is picked from the available pool of specialists in the field of classification, in this instance the field of oil painting. Each of the submitted works is provided with an identifier SUB1 to SUB5, indicated in FIG. 2 at blocks 80A to 80E. Each judge is then asked to rate each of the subject works based on the parameters that are appropriate for the type of work. For example, SUB1 is rated for each parameter ATT1 through ATT5 as indicated by blocks 90A to 90E. For each parameter, a rating of Ito 10 is given. Each rating is then multiplied by an appropriate weighting factor Y to produce a net rating TS (talent score) for each parameter. As noted above, the value of Y for each parameter may be different. However, the average value is selected so that the total of all net ratings CTS (combined talent score) for a particular work (blocks 100) does not exceed some pre-selected value, for example, 1000. The CTS rating for each work is then averaged to produce an Average Talent Score ATS (blocks 110) for the artist from each judge. While it may be preferable to use an “average”, the ATS value could also be obtained as a mean or a median or such other averaging technique as to give a fair evaluation to the set of individual scores. Finally, the ATS value derived from each judge's evaluation is then processed by averaging to obtain a single Talent Rating (TR). The TR rating may be an average or may also be obtained by other methods such as a mean or median determination.

The result of the evaluation is provided to the artist to assist him in further development his/her expertise or in understanding his/her level of skill in the relevant art as determined by the panel of experts. The artist may use the information to identify areas of improvement or even a complete change in direction.

What is claimed is:

1. A talent analysis and evaluation method for an artist comprising:
receiving a body of work from an artist, the body of work including a plurality of items in an artistic category;
selecting a group of experts in the artistic category;
arranging for each of the experts of the group of experts to independently evaluated each of the items in the body of work received from the artist, each of the experts providing a numerical rating for each item in the body of work;
applying an algorithm to the ratings from each of the experts to normalize the ratings to a predetermined scale; and
computed a final composite rating for the body of work of the artist.

2. The method of claim 1 wherein the experts rate each of the items in the body of work on a scale having a preset range.

3. The method of claim 2 wherein the final composite rating is based on an average rating of all items in the body of work from each expert averaged over all of the experts.
